(19) United States
(12) Patent Application Publication
(10) Pub. No.: US 2005/0056661 A1
(43) Pub. Date: Mar. 17, 2005

(54) Method and system for distributing hydrogen

(75) Inventors: Chris Casamatta, Mississauga (CA); Paul Hennessy, Richmond Hill (CA); Peter Firsov, Brampton (CA); Charley Pappas, Scarborough (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Hydrogenics Corporation, Mississauga (CA)

(21) Appl. No.: 10/921,353

(22) Filed: Aug. 19, 2004

Related U.S. Application Data
(60) Provisional application No. 60/495,894, filed on Aug. 19, 2003.

(51) Int. Cl. B67D 5/00

(52) U.S. Cl. 222/3

(57) ABSTRACT

A hydrogen distribution system and method for distributing hydrogen between a plurality of hydrogen receiving units arranged in parallel. Hydrogen may be supplied to the system from a hydrogen source such as a hydrogen generator, or a hydrogen storage tank. The system and method may distribute hydrogen to receiving units such as a storage system, a user, or a fuel cell power module.

### RELATED APPLICATION

This application claims the benefit of U.S. provisional application No. 60/495,894, entitled HYDROGEN AND ELECTRICITY GENERATING SYSTEM, which was filed by Charley Pappas, Chris Casamatta, Peter Firsov and Paul Hennessy on Aug. 19, 2003, and the entire content of which is hereby incorporated by reference.

### FIELD OF THE INVENTION

This invention relates to systems for providing/generating hydrogen and electric power. More particularly, this invention relates to such systems utilizing a hydrogen reforming sub-system including hydrogen storage and a fuel cell sub-system.

### BACKGROUND TECHNOLOGY

There are several instances where a power/hydrogen generator system is desirable or needed, for example for use with hydrogen powered vehicles or for powering stationary loads such as buildings.

Fuel cells have been proposed as a clean, efficient and environmentally friendly power source that has various applications. A conventional proton exchange membrane (PEM) fuel cell typically comprises an anode, a cathode, and a selective electrolytic membrane disposed between the two electrodes. A fuel cell generates electricity by bringing a fuel gas (typically hydrogen) and an oxidant gas (typically oxygen) respectively to the anode and the cathode. In the reaction, a fuel such as hydrogen is oxidized at the anode to form cations (protons) and electrons by the reaction H₂=2H⁺+2e⁻. The proton exchange membrane facilitates the migration of protons from the anode to the cathode while preventing the electrons from passing through the membrane. As a result, the electrons are forced to flow through an external circuit thus providing an electrical current. At the cathode, oxygen reacts with electrons returned from the electrical circuit to form anions. The anions formed at the cathode react with the protons that have crossed the membrane to form liquid water as the reaction by-product following: O₂+2H⁺+2e⁻=H₂O. Individual fuel cells are usually interconnected in a series arrangement, often called “stacks”.

In stationary applications, fuel cell stacks are usually used as an electrical power source and are simply expected to run at a relatively constant power level for an extended period of time.

### SUMMARY OF THE INVENTION

A power/hydrogen generator system according to aspects of the invention generally has the following components: a hydrogen reformer, such as a Steam Methane Reformer (SMR) based fuel processor, for producing syngas from natural gas (containing Methane gas); a syngas high pressure compressor connected to the hydrogen reformer, for providing pressurized syngas; a pressure swing adsorption unit (PSA) connected to the syngas high pressure compressor, for purifying the syngas to produce high purity hydrogen gas; a hydrogen fuel gas distribution unit connected to the pressure swing adsorption unit and the hydrogen gas storage unit, for dividing and providing hydrogen gas to hydrogen gas receiving units such as the fuel cell power modules (FCPM) of the system, external users (vehicles or stationary), and other parts of the system itself; and a fuel cell power generating unit having at least one fuel cell power module connected to the hydrogen fuel gas distribution unit, for producing electricity.

Advantageously, the power/hydrogen generator system further has a refueler/dispenser unit, connectable to a hydrogen receptacle arranged on a hydrogen consuming device, for supplying hydrogen gas from the system to the hydrogen consuming device.

Further, the power/hydrogen generator system may have a hydrogen gas storage unit connected to the PSA; a water treatment unit, for delivering process water to the system; and a thermal treatment unit, for cooling/heating of the system.

The system is either stationary, i.e. is used in a specific location and is not intended to be used whilst moving, or mobile, i.e. intended to be used whilst the whole system is moving, e.g. mounted on a vehicle.

Natural gas and water are fed into the system for the main reaction. The output is reformate (syngas), condensate and vent. The SMR based fuel processor has a de-sulfurizer, a natural gas compressor, a water pump, a boiler, a steam methane reactor and high/low temperature shift. Reformate from the SMR based fuel processor has roughly 77% hydrogen (dry basis), with the balance of the gas consisting of carbon dioxide, moisture and a very small amount of carbon monoxide and methane (these values may vary based on natural gas supply and mode of operation).

To effectively utilize the hydrogen produced from a SMR based fuel processor for a refueling application, the reformate gas must be purified to near pure hydrogen due to the inefficient nature of storing the balance gases. Due to the relatively small size requirements of the hydrogen gas, balance gases occupy much more space than hydrogen, which thereby reduces the capacity of the storage system and makes it much more difficult to design and control the fuel cell power system. To alleviate these design and storage issues, a multi-bed PSA system is utilized to remove the impurities. The system stores and delivers near pure hydrogen with a purity of 99.95% or greater. For the PSA system to be most effective, the PSA requires a minimum pressure of 8.5 bar(g). Therefore, since the SMR operates at approx. 0.34 bar(g), a boost compressor, designed for reformate, increases the pressure to 8.5 bar(g) to ensure that the PSA is operating effectively.

This is done with a syngas compressor and the compressed gas is passed to a PSA from which the exhaust gas is returned to the SMR based fuel processor to be used for creating steam. The pure hydrogen is sent to the high pressure compressor to increase the pressure of the hydrogen gas (to approx. 5000 psi(g), for example) for storage in the hydrogen storage unit.

Two compressors may be used for the syngas compressing stage and a separate compressor for high pressure compression. Alternatively, a single multi-stage compressor is used, where the compressor is balanced to accept the reformate into the first stage where the pressure is increased to typically 100-150 psi(g). The reformate is then sent to the PSA after which the purified hydrogen is returned to the second stage inlet where it continues through the third, fourth and possibly a fifth compression stage to achieve the desired high pressure. This concept works with a two, three, four or five stage compressor.

The power management arrangement is designed to allow the FCPM to receive hydrogen from the PSA or the hydrogen storage directly so that power delivered could take the form of grid synchronized power, APU, or back power.

The thermal management is achieved with a combination of forced air radiators and chiller systems. This allows enhanced control and optimizes the power consumption depending on the mode of operations. The forced air systems supply a rough heat removal mechanism for the compressors and the power module, and the chiller provides the more intense cooling requirement for the SMR based fuel processor. Alternatively, combined heat and power packages integrate the heat rejection system with users heat usage systems. Automated roof louvers and a variable speed motor modulate the air flow to only reject the heat necessary and control the environment within the container.

The hazardous and non-hazardous areas of the system are separated by a two hour fire rating wall and the walls are arranged to minimize the wiring between the two areas. This is a huge cost and safety benefit.

Safety mechanisms are designed into the logic of the system. Everything is designed to failsafe in case of an upset. The system will shutdown on flame, carbon monoxide, oxygen deficiency, over-temperature, and overpressure detection. The roof louvers and forced air system will increase to evacuate the air from the container in case of oxygen deficiency and carbon monoxide leakage.

In accordance with an aspect of the invention there is provided a hydrogen distribution system comprising a hydrogen source; a plurality of hydrogen receiving units for selectably receiving hydrogen gas; a hydrogen distribution unit for receiving hydrogen gas from the hydrogen source and for distributing hydrogen gas between the plurality of hydrogen receiving units, wherein the plurality of hydrogen receiving units are connected to the hydrogen distribution unit in parallel; and a control unit for providing a plurality of control instructions, the plurality of control instructions comprising (i) at least one hydrogen source control instruction for controlling the hydrogen source, (ii) at least one receiving unit control instruction for controlling at least one of the hydrogen receiving units, and (iii) at least one distribution unit control instruction for controlling the hydrogen distribution unit.

In accordance with another aspect of the invention there is provided a method of distributing hydrogen from a hydrogen source to a plurality of receiving units via a hydrogen distribution system, the method comprising: (a) monitoring a hydrogen source and a plurality of hydrogen receiving units to determine a plurality of operating indicators, the plurality of operating indicators comprising (i) a hydrogen source operating condition for indicating an operating condition of the hydrogen source, (ii) at least one receiving unit operating condition for indicating operating conditions of at least one of the hydrogen receiving units; (b) determining a plurality of control instructions based on the plurality of operating indicators, the plurality of control instructions comprising (i) at least one hydrogen source control instruction for controlling the hydrogen source, (ii) at least one receiving unit control instruction for controlling at least one of the hydrogen receiving units, and (iii) at least one distribution unit control instruction for controlling the hydrogen distribution unit; and (c) based on the plurality of control instructions, controlling (i) the hydrogen hydrogen source and the hydrogen distribution system to selectably provide hydrogen to the plurality of hydrogen receiving units, and (ii) the operation of at least one hydrogen receiving unit.

### BRIEF DESCRIPTION OF THE DRAWINGS

For a better understanding of the present invention, and to show more clearly how it may be carried into effect, reference will now be made to the accompanying drawings which show, by way of example, preferred embodiments of the present invention, and in which;

FIG. 1 is a schematic view showing a power/hydrogen generator system according to an aspect of the present invention;

FIG. 2 is a schematic view of a SMR based fuel processor of the power/hydrogen generator system of FIG. 1;

FIG. 3 is a schematic view of a syngas compressor of the power/hydrogen generator system of FIG. 1;

FIG. 4 is a schematic view of a PSA of the power/hydrogen generator system of FIG. 1;

FIG. 5 is a schematic view of a high pressure hydrogen gas compressor of the power/hydrogen generator system of FIG. 1;

FIG. 6A is a first part of a schematic view of a hydrogen distribution system of the power/hydrogen generator system of FIG. 1;

FIG. 6B is a second part of a schematic view of a hydrogen distribution system of the power/hydrogen generator system of FIG. 1;

FIG. 7 is a schematic view of a hydrogen gas storage unit of the power/hydrogen generator system of FIG. 1;

FIG. 8 is a schematic view of a refueler/dispenser unit of the power/hydrogen generator system of FIG. 1;

FIG. 9A is a flowchart showing a start sequence branch of the power/hydrogen generator system control program according to an aspect of the present invention;

FIG. 9B is a flowchart showing a refuel branch of the power/hydrogen generator system control program of FIG. 9A;

FIG. 9C is a flowchart showing a hydrogen storage system fill selection latch branch of the power/hydrogen generator system control program of FIG. 9A;

FIG. 9D is a flowchart showing a hydrogen storage system fill selection unlatch branch of the power/hydrogen generator system control program of FIG. 9A;

FIG. 9E is a flowchart showing a fuel cell power generating unit run selection latch branch of the power/hydrogen generator system control program of FIG. 9A;

FIG. 9F is a flowchart showing a fuel cell power generating unit run selection unlatch branch of the power/hydrogen generator system control program of FIG. 9A;

FIG. 9G is a flowchart showing a fuel cell power generating unit run branch of the power/hydrogen generator system control program of FIG. 9A;

FIG. 9H is a flowchart showing a hydrogen storage fill branch of the power/hydrogen generator system control program of FIG. 9A;

FIG. 9I is a flowchart showing a hydrogen generation unit run branch of the power/hydrogen generator system control program of FIG. 9A;

FIG. 9J is a flowchart showing distribution unit/fuel cell power generating unit send fuel branch of the power/hydrogen generator system control program of FIG. 9A;

FIG. 10 is a block diagram illustrating hydrogen flow paths between components of the power/hydrogen generator system in accordance with an aspect of the present invention; and

FIG. 11 is a block diagram illustrating a control unit of the power/hydrogen generator system in accordance with an aspect of the present invention.

### DETAILED DESCRIPTION OF PREFERRED EMBODIMENTS OF THE INVENTION

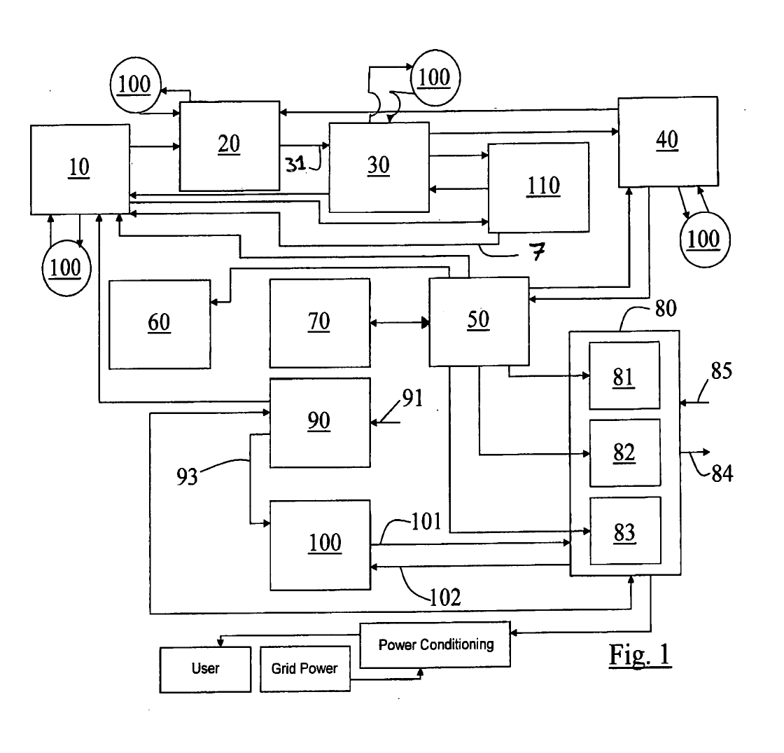

FIG. 1 shows a stationary power/hydrogen generator system according to an aspect of the present invention. A hydrogen reformer, such as a Steam Methane Reformer (SMR) based fuel processor 10, for producing syngas from natural gas (containing Methane gas) is used. The syngas produced is compressed using a syngas high pressure compressor 20. To purify the syngas, a pressure swing adsorption unit (PSA) 30 to produce high purity hydrogen gas is used. For efficient storage, the hydrogen gas is compressed using a hydrogen gas compressor 40 and thereafter stored in a hydrogen storage unit 70. A hydrogen fuel gas distribution unit 50, divides and provides hydrogen gas to hydrogen gas users such as directly to fuel cell power modules (FCPM) 81, 82, 83 of the system, external users via a refueler/dispenser unit 60 (vehicles or stationary) and other parts of the system itself (such as the storage unit 70). Further, a water treatment unit 90 is used to handle water purification requirements of the system. A thermal management unit 100 (FCPM heat rejection unit) is used to handle the cooling/heating requirements of the fuel cells (fuel cell stacks, not shown), SMR based fuel processor 10, syngas compressor 20, PSA 30 and high pressure compressor 40. A fuel cell power generating unit 80 has at least one FCPM 81, 82, 83. A chiller system 110 is arranged to provide thermal management, a combination of forced air radiators and chilling is used.

The water treatment unit 90 receives water (municipal water or other supplier) via a water inlet 91, and provides DI water (deionized water) to the heat management unit 100 via a connection 93. DI water is also made available to the SMR based fuel processor 10, as will be described later. The exhaust (combustibles separated from non-combustibles) and condensate drained from the FCPMs leave the fuel cell power generating unit 80 via exhaust 84, whilst ambient air enters via inlet 85. Coolant enters the fuel cell power generating unit 80 from the heat management unit 100 via connection 101, and return coolant flows from the fuel cell power generating unit 80 to the heat management unit 100 via connection 102.

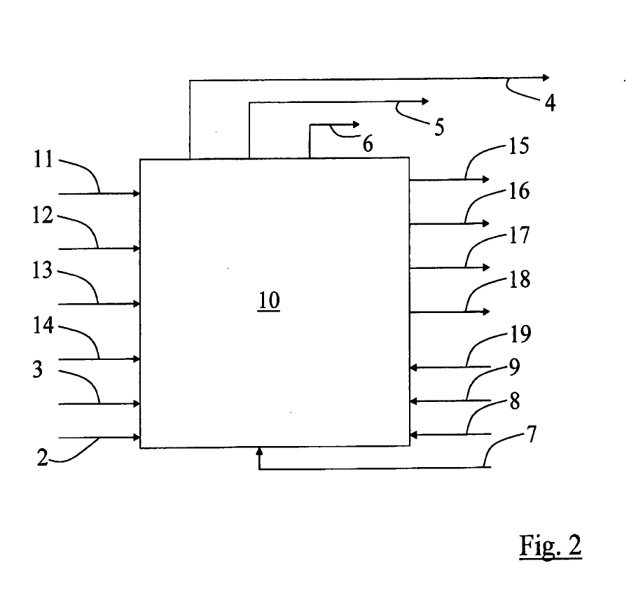

Turning to FIG. 2, the SMR based fuel processor 10 has the following inputs: natural gas supply 11, air supply 12, instrument air supply 13, chiller supply 7 from the chiller 110, water supply 8 from the water treatment unit 90, start-up hydrogen supply 9 from the hydrogen storage unit 70, combustion air supply 19, PSA Tail-Gas 3, hydrogen recirculation 2 from PSA 30, and nitrogen supply 14. The SMR further has the following outputs: syngas 4 to the syngas compressor 20, chiller return 5, gas sample output 6 (sampler not shown), combustible vent 15, boiler blow-down 16, flue gas exhaust 17 and condensate drain 18.

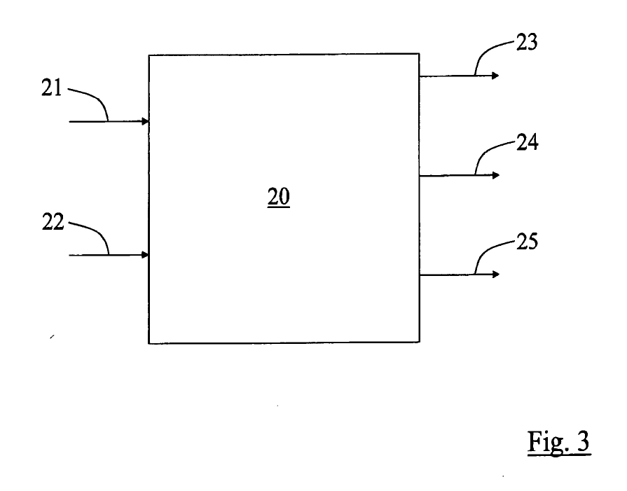

The syngas compressor 20, see FIG. 3, has the following inputs: syngas input 21 from the SMR based fuel processor 10 and blow-down 22 from the high pressure compressor 40. The syngas compressor 20 further has the following outputs: compressed syngas 23 to the PSA 30, condensate drain 24 and combustible vent 25.

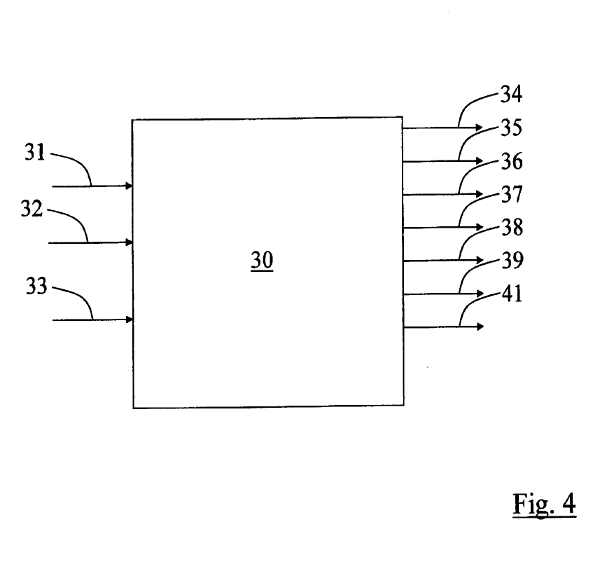

As is shown in FIG. 4, the PSA 30 has the following inputs: syngas input 31 from the syngas compressor 20, chiller supply 32 and instrument air 33. Further, the PSA has the following outputs: product gas 34 to the hydrogen gas compressor 40, chiller return 35 to chiller 110, condensate drain 36, syngas gas recirculation 37 to SMR based fuel processor 10, PSA Tail-Gas 38 to syngas compressor 20, combustible vent 39 and gas sample outlet 41 to analyzer (not shown).

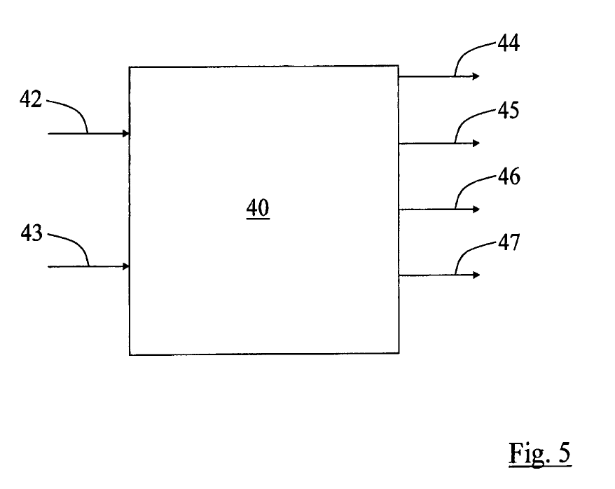

FIG. 5 shows the hydrogen gas compressor 40 having the following inlets: PSA product gas inlet 42 from PSA 30, and startup hydrogen inlet 43 from the hydrogen distribution unit 50. The hydrogen gas compressor 40 has the following outlets: low pressure hydrogen gas supply 44 to the hydrogen distribution unit 50, high pressure hydrogen supply 45 to the hydrogen distribution unit 50, blow-down 46 to the syngas compressor 20 and combustible vent 47.

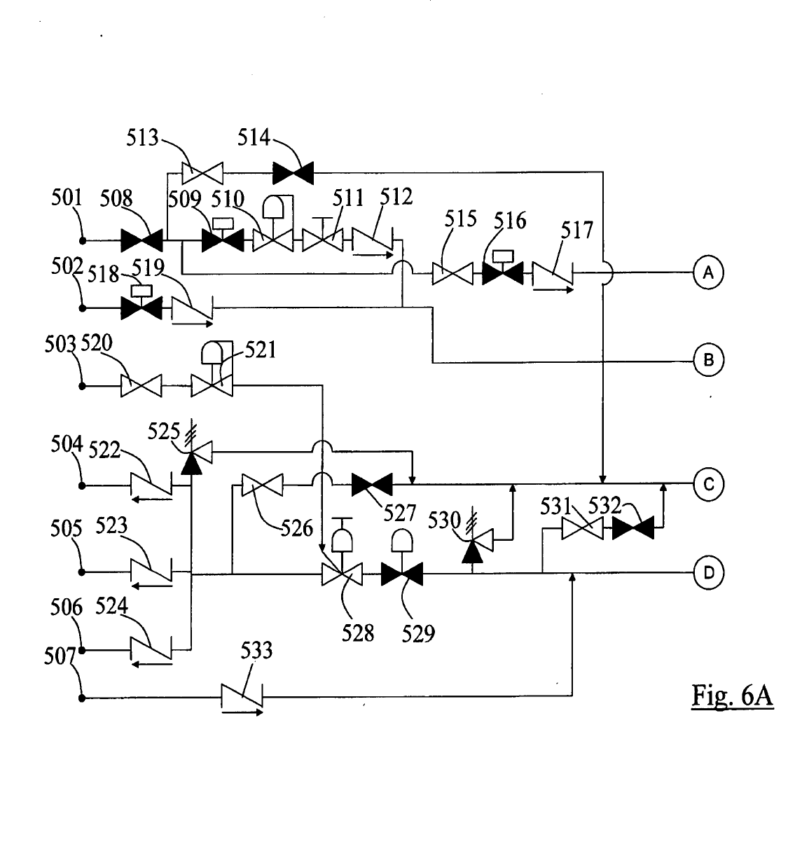

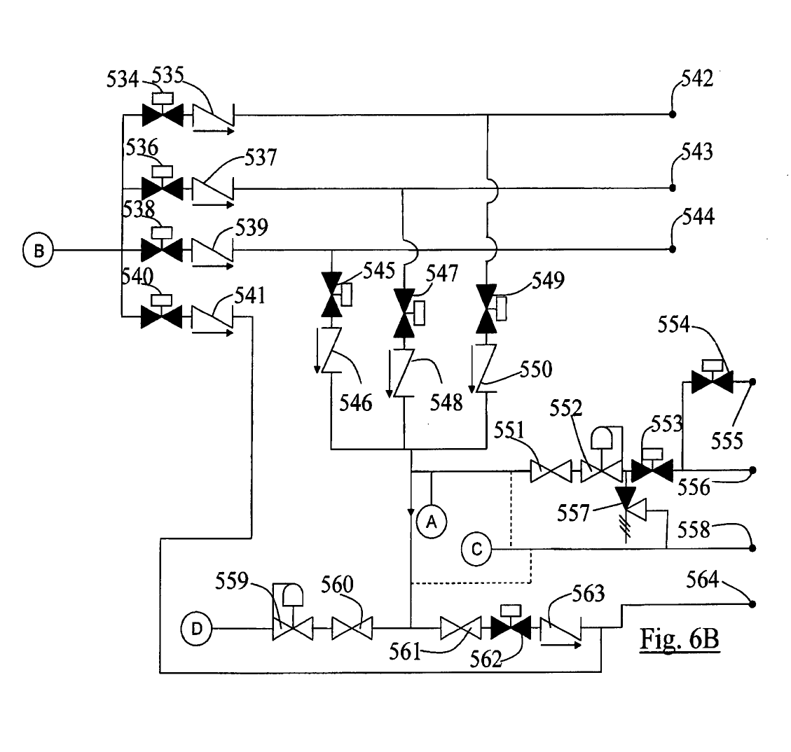

FIGS. 6A and 6B in combination show the hydrogen distribution unit 50. The points A, B, C and D respectively in the two figures are connected A to A, B to B, C to C and D to D. An external hydrogen supply 501 (from any available external hydrogen supply system, not shown) is connected to the unit via an external hydrogen valve 508. A hydrogen supply input 502 from the hydrogen compressor 40 is connected to the unit via a hydrogen electric shut-off valve 518 and a hydrogen check valve 519, and connects to point B. External hydrogen from external input 501 is connected to the “regular” hydrogen input 502 via an external hydrogen electric shut-off valve 509, a pressure regulating valve 510, a manual shut-off valve 511 (for manual override), and an external hydrogen check valve 512. Start-up hydrogen is fed to point A via a normally open valve 515, an electric shut-off valve 516 and a check valve 517. Instrument air is fed to the unit via instrument air valve 520 and instrument air pressure regulating valve 521. Hydrogen is fed to the FCPMs (in the shown example three FCPMs) via hydrogen outlets 504, 505 and 506, respectively. Each outlet has an outlet check valve 522, 523 and 524, respectively, which are fed via a manual dome-loaded pressure valve 528, fed via instrument air inlet 503, and an air-actuated (pneumatic) shut-off valve 529. Hydrogen from hydrogen input 507 connected to the hydrogen compressor 40 enters the unit via check valve 533 and is provided to point D. Point C designates a combustible vent (reference number 558 of FIG. 6B). The external hydrogen inlet 501 is vented to the combustible vent header via valves 513 and 514 in a known manner. Similarly, the fuel cell power generating unit 80 hydrogen feed is vented to the combustible vent via valves 526/527 and 531/532. Furthermore, a first safety valve 525 and a second safety valve 530 vents the fuel cell power generating unit 80 hydrogen feed to the combustible vent.

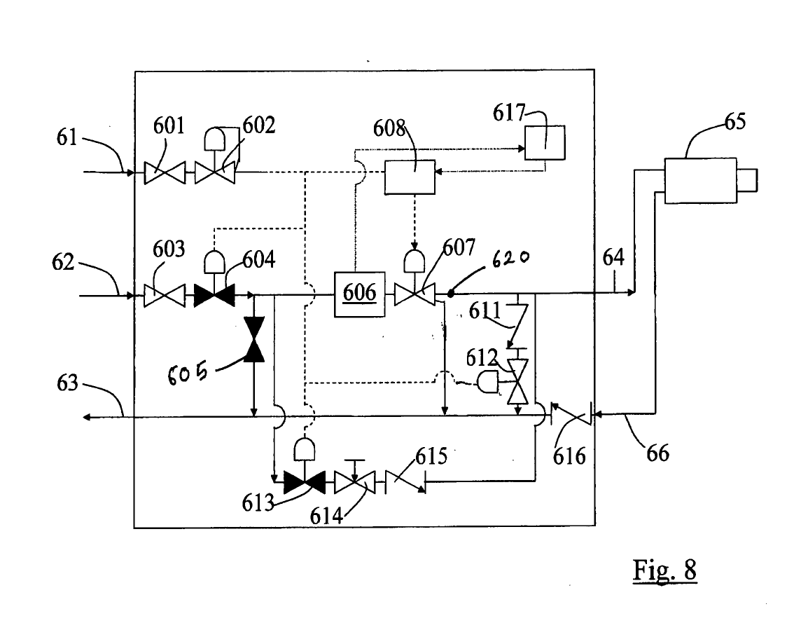

FIG. 6B shows how the hydrogen input from either inlet 501 or inlet 502 is connected to the hydrogen storage unit 70 (see FIG. 1) via electric shut-off valves 534, 536 or 538, respectively (three storage modules are shown in the example), and check valves 535, 537 or 539 respectively. The hydrogen storage outlets are designated 542, 543 and 544, respectively. Alternatively, hydrogen gas can be connected to the FCPMs directly, to the refueler/dispenser 60 directly or to start-up hydrogen outputs of the unit. This connection is made via electric shut-off valves 545, 547 and 549, respectively (still taking into account that three storage modules are shown in the example), and check valves 546, 548 and 550, respectively. When the FCPMs are connected directly to the hydrogen inputs, the gas flows via hydrogen outlet valve 560 and hydrogen outlet pressure valve 559 to point D and further to hydrogen outlets 504, 505, and 506, respectively (three FCPMs being shown in the example). For hydrogen gas connection to the refueler/dispenser unit 60, hydrogen gas flows via refuel valve 561, electric refuel shut-off valve 562 and refuel check valve 563 to a refuel outlet 564, which is connected to the refueler/dispenser unit 60 (FIGS. 1 and 8). Start-up hydrogen is supplied via hydrogen start-up valve 551, hydrogen start-up pressure valve 552 and hydrogen start-up electric shut-off valve 553 to a first hydrogen start-up outlet 556 connected to the SMR based fuel processor 10, and further via electric shut-off valve 554 to a second hydrogen start-up outlet 555 connected to the hydrogen compressor 40. The hydrogen outlets to fuel cell power generating unit 80 and for start-up hydrogen are vented to the combustible vent 558 as indicated by the dashed lines, similar to what has been described regarding FIG. 6A. Further, a third safety valve 557 vents the start-up hydrogen to the combustible vent.

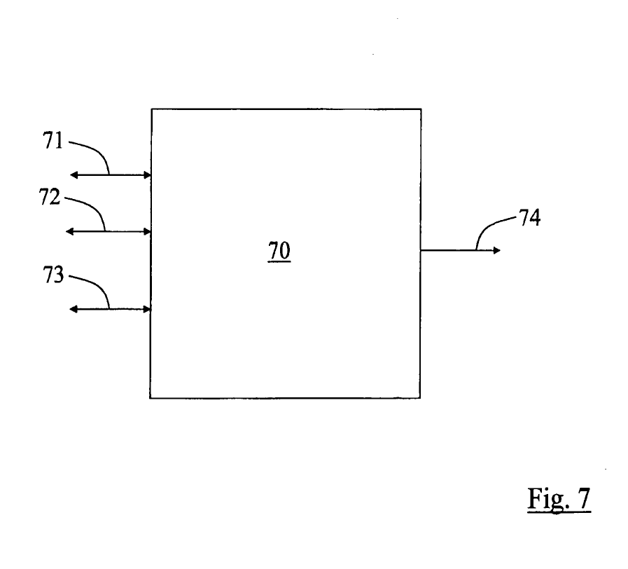

FIG. 7 shows the hydrogen storage unit 70 having separate inputs 71, 72 and 73, respectively for each storage module (storage bank, not shown). A combustible vent outlet 74 is also present.

The refueler/dispenser 60 is shown in FIG. 8. An instrument air supply 61 is connected to the refueler 60 via an instrument air valve 601 and an instrument air pressure control valve 602. A hydrogen gas inlet 62 is connected to the hydrogen gas distribution unit 50, and provides hydrogen gas via a hydrogen inlet valve 603, a first pressure control valve 604, a flow/temperature sensor 606, a flow control valve 607 to a hydrogen outlet connection 64, for example a conductive hose, and a pressure sensor 620. A fueling nozzle 65 is connected to the hose, to allow hydrogen gas to be filled into a storage tank (not shown) of a vehicle (not shown) or other hydrogen gas consuming device. A vent line 66, for example a conductive hose, vents surplus hydrogen gas from the nozzle back to the refueler/dispenser 60 via a vent check valve 616. The hoses are preferably connected to the refueler 60 and the nozzle using break-away connections. A bypass valve 605 is connected to provide input hydrogen gas directly to a combustible vent outlet 63, in case this is necessary. The vent check valve 616 is also connected to the vent outlet. The flow is controlled by flow control valve 607 via data receiver 617 and controller 608. Items 611 and 612 are utilized to depressurize the dispenser after a vehicle has been filled or during maintenance. A pressure valve 613, manual shut-off valve 614 and a check valve 615 are used for manual override or bypass operation where the operator manually fills the vehicle under limited and restricted set of parameters.

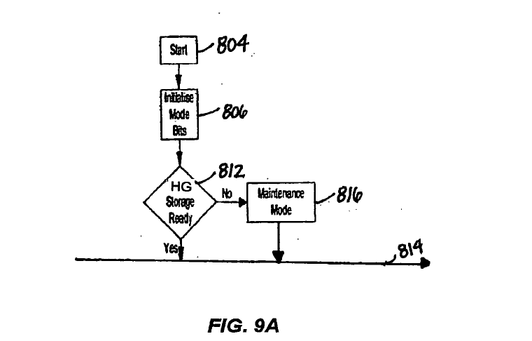

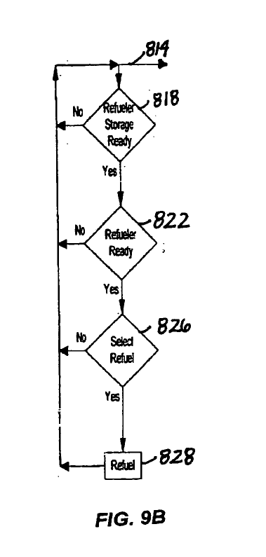

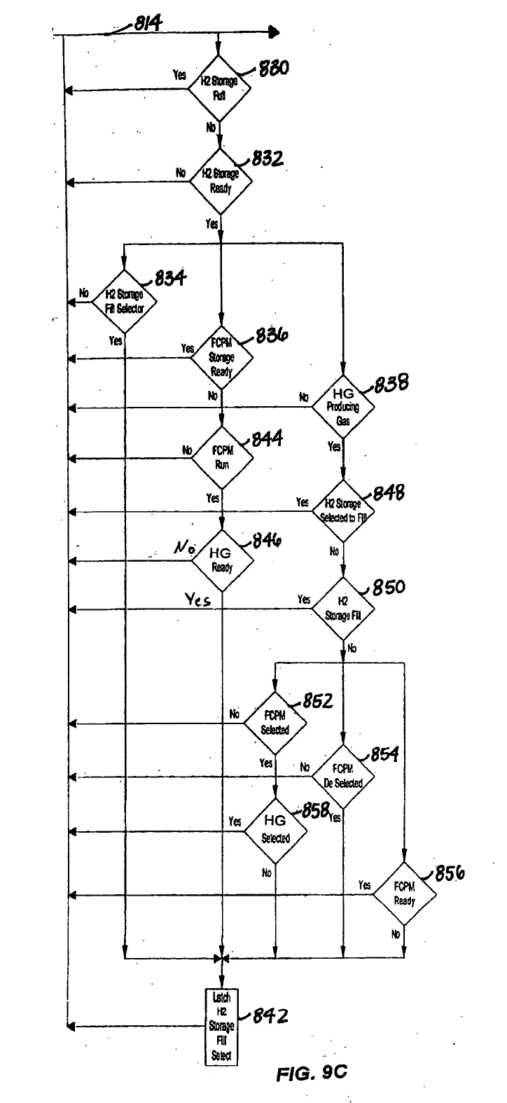

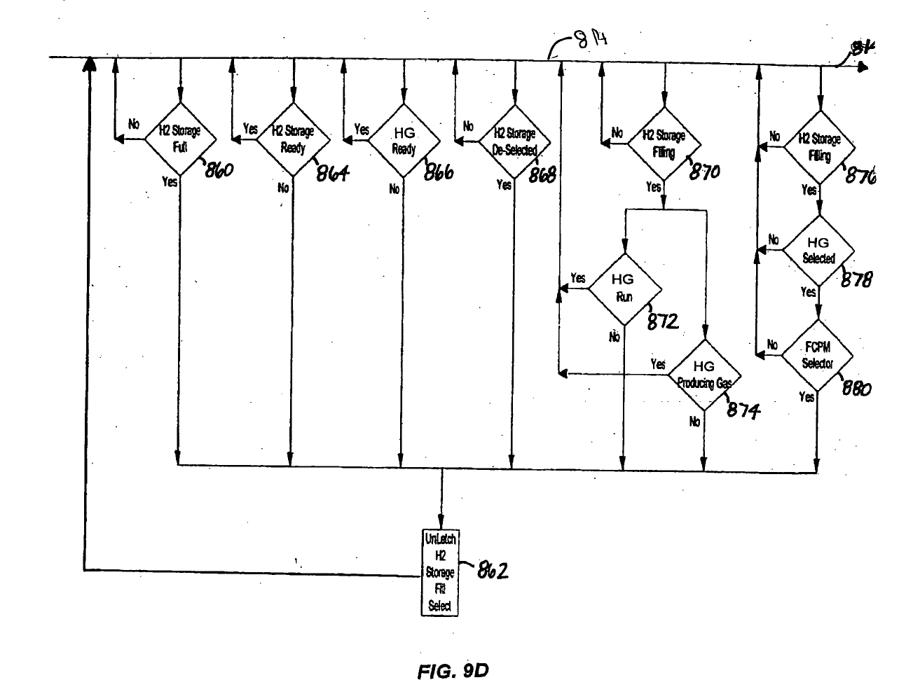

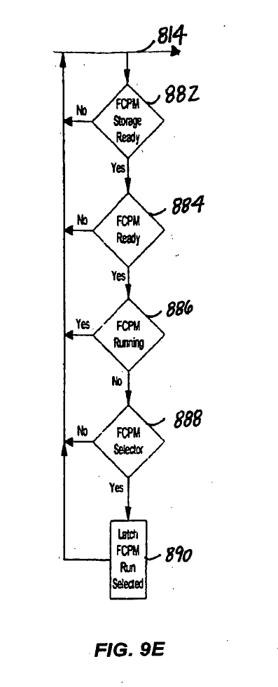

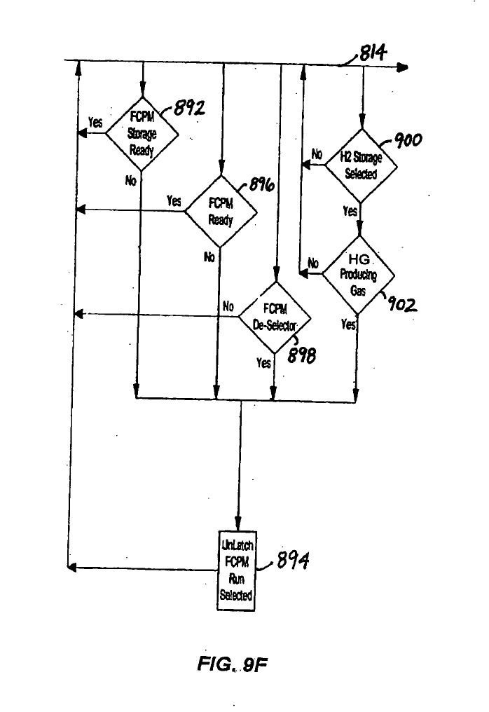

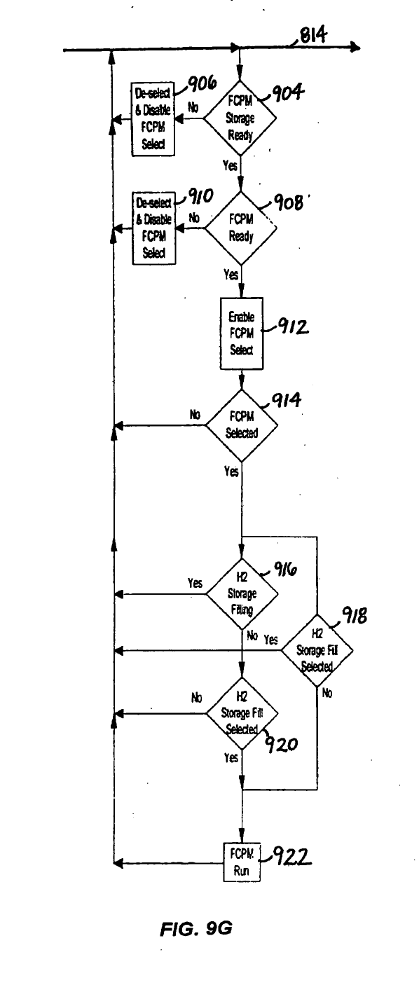

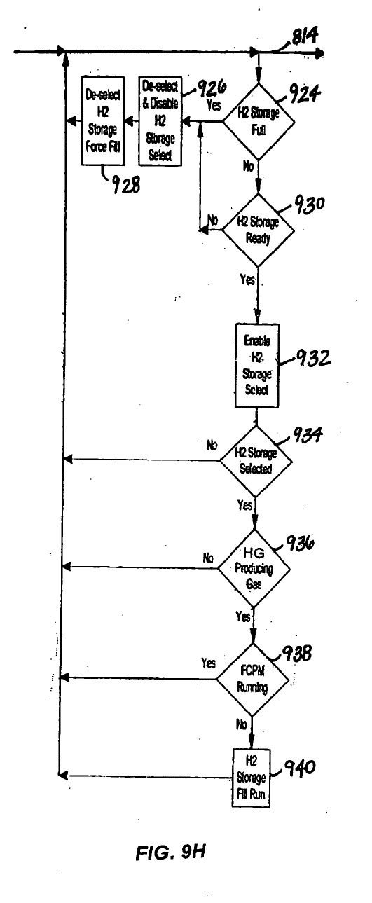

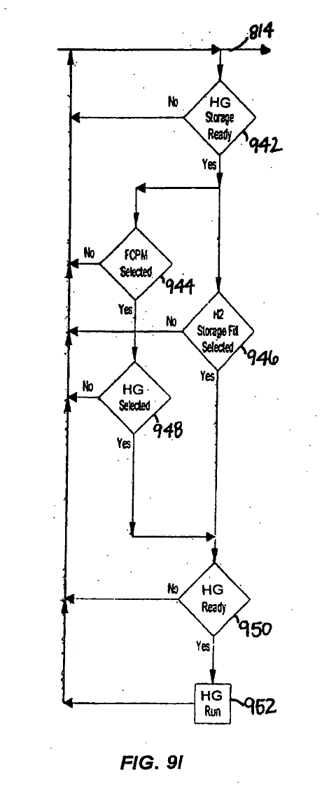

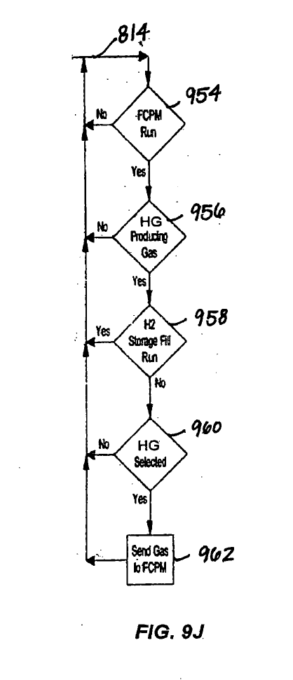

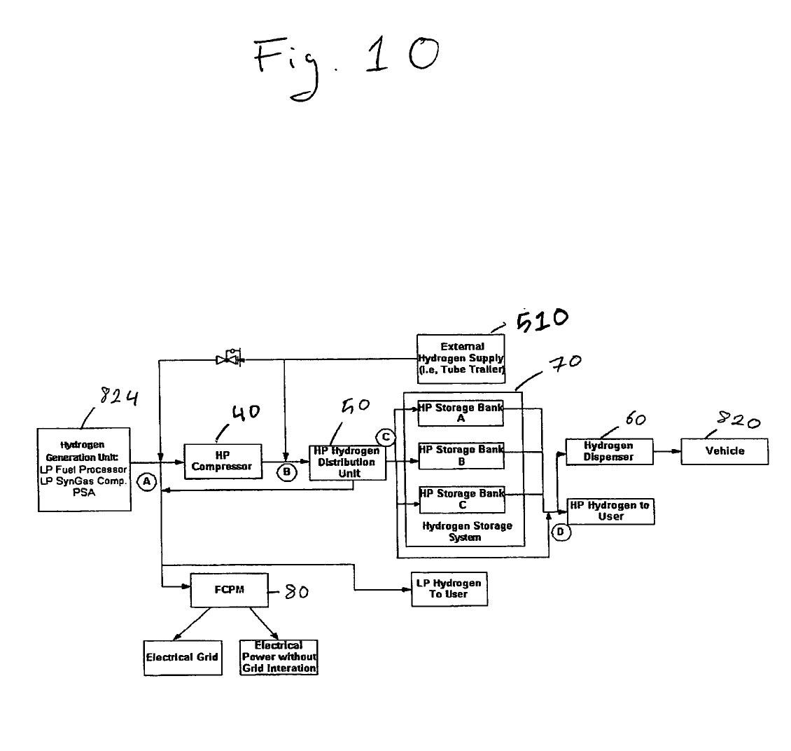

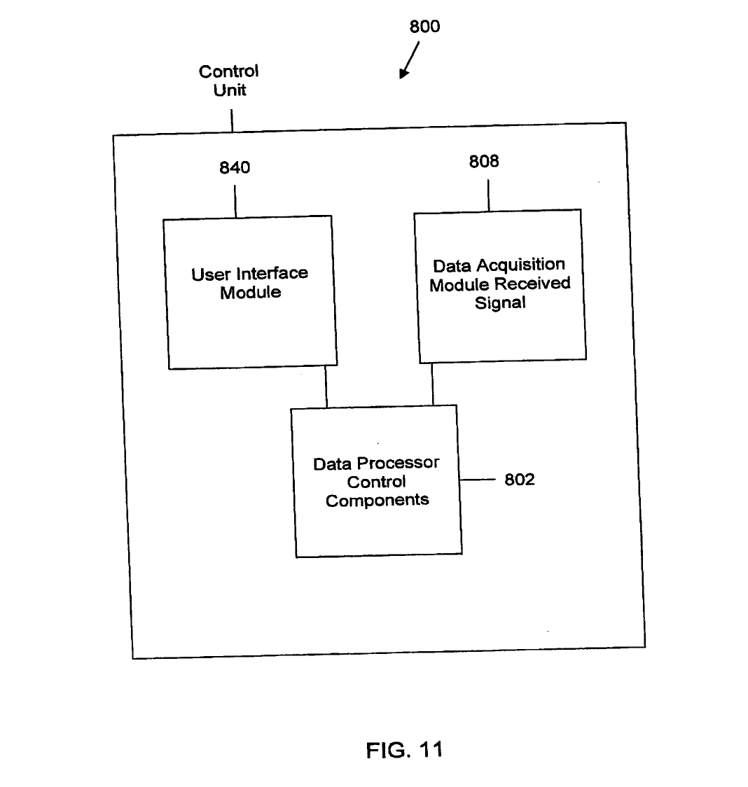

According to a preferred embodiment of the present invention, all of the components of the power/hydrogen generator system are controlled according to a control program. Referring to FIGS. 9A, 9B, 9C, 9D, 9E, 9F, 9G, 9H, 9I, and 9J, the internal logic of this control program is illustrated in a series of flowcharts. In FIG. 10, a block diagram is provided that illustrates the hydrogen flow paths between the individual components of the power/hydrogen generator system. Referring to FIG. 11, there is illustrated in a block diagram, a control unit 800 having a data processor 802 configured by the control program of FIGS. 9A to 9J to control individual components of the power/hydrogen generator system shown in FIG. 10, such that the system operates as an integrated unit.

Referring to FIG. 9A, a start sequence branch is illustrated in a flowchart. The control program and start sequence branch begin at step 804, in which the power/hydrogen generator system is turned on. The control program then proceeds to step 806, in which the control unit 800 of FIG. 11, which controls the various components of the power/hydrogen generator system, is initialized.

Referring to FIG. 10, there are at least two ways to start the power/hydrogen generator system. Preferably, there is at least some minimal amount of hydrogen stored in the hydrogen storage unit 70 such that the power/hydrogen generator system can commence operation on its own. To determine if a sufficient amount of hydrogen is stored in the storage unit 70, a pressure sensor located in the storage unit 70 measures the pressure of hydrogen stored in the storage unit 70. This pressure sensor sends a message back to a data acquisition module 808 of the control unit 800 of FIG. 11. If insufficient hydrogen is stored in the storage unit 70, then the system can also be started by providing hydrogen from an external source 510.

Following step 806, as shown in FIG. 9A, the control program proceeds to query 812, in which, using the pressure information received from the pressure sensor in the storage unit 70 the data processor 802 configured in accordance with the control program of FIGS. 9A to 9J can determine whether there is sufficient hydrogen in the storage unit 70 to commence operation of the power/hydrogen generator system. If there is sufficient hydrogen in the storage unit 70, the control program returns to monitoring stage 814. Alternatively, if the amount of hydrogen in the storage unit 70 is insufficient to commence operation of the system, then the control program proceeds to step 816, in which a maintenance mode is triggered. In this maintenance mode, hydrogen may be supplied from an external source 510, such as a truck, in order to provide the minimal amount of hydrogen required to commence operation to the storage unit 70. When the minimal amount of hydrogen required to start the power/hydrogen generator system has been supplied, the control program will returns to monitoring stage 814. This determination that sufficient hydrogen is stored in storage unit 70 is made by the data processor 802 of the control unit 800 shown in FIG. 11, based on pressure information received from the pressure sensor in the storage unit 70.

Once there is sufficient hydrogen to start the power/hydrogen generator system, the control program returns to monitoring stage 814, at which different conditions of the system are monitored, which monitoring provides feedback for controlling the system. This monitoring and steps taken based on the monitoring are illustrated in the series of vertically oriented branches, illustrated in FIGS. 9B-9J, extending downward from the monitoring stage 814. Controlling the system involves controlling the distribution of hydrogen to the components of the system. As discussed above in relation to FIGS. 6A and 6B, the hydrogen distribution unit 50 implements this distribution of hydrogen.

Referring to FIG. 9B, a refuel branch extending from the monitoring stage 814 is illustrated in a flowchart. In query 818, the control program checks whether the refueler storage is ready. As shown in FIG. 10, the refueler storage is ready when there is sufficient hydrogen in the storage unit 70, to dispense hydrogen to, say, a vehicle 820, via the hydrogen dispenser 60, which determination may be made by the data processor 802 of FIG. 11 based on the pressure of stored hydrogen measured by the pressure sensor located in the storage unit 70. Alternatively, if there is insufficient hydrogen in the storage for refueling operations, the control program will return to the monitoring stage 814. If, however, there is sufficient hydrogen in storage to begin refueling, the control program proceeds to query 822, which checks whether the refueler is ready.

The control unit 800, as shown in FIG. 11, monitors the readiness of different elements of the power/hydrogen generator system, by monitoring operating indicators for each of these different elements indicating the readiness of different components for different operations. For example, as described above, the pressure measurement received from the storage unit 70 represents the readiness of the storage unit 70 for different functions. The control program installed in the control unit 800 will also include an operating indicator for indicating the operational status of the refueler.

In query 822, the control program checks the operating indicator for the refueler to determine whether the refueler is ready. For example, the refueler may include sensors for indicating its basic operational state, which sensors provide information to the control unit 800 to provide the operating indicator for the refueler, including a warning indicator indicating when there is a problem with the refueler. The refueler is ready if the hydrogen dispenser 60 is fully operational and there are no other reasons, other than the level of hydrogen in the storage unit 70 being too low, that will prevent hydrogen from being dispensed. If such problems exist, then the control program returns to monitoring stage 814.

The control unit 800 of FIG. 11 also comprises a user interface module 840, which may be distributed such that, for example, a user can provide the required user input at a convenient location. For example, when using the refueler, the user can simply select the refueler at the refueler (similar to, say, the selection of a type of fuel, at a gas station pump. Using this user interface module 840, a user can SELECT, or DE-SELECT, either the hydrogen generation unit 824 or different hydrogen receiving units within the power/hydrogen generator system. For example, if the user wishes to dispense hydrogen to a vehicle 820 via the hydrogen dispenser 60, then the user can, via the user interface module, SELECT the refueler. As will be described below, the control program of FIGS. 9A to 9J may also SELECT or DE-SELECT different components of the power/hydrogen generator system. When a user selects the refueler, this information is sent to the data processor 802.

Referring back to FIG. 9B, if query 822 return the answer YES, in that the refueler is ready, the control program proceeds to query 826, in which the control program checks whether the refueler or refuel operation has been selected. If the refueling operation is not selected, then the control program returns to monitoring stage 814. If, on the other hand, the refueling operation is selected, then the control program proceeds to step 828, in which the control program sends a control instruction from the control unit 800 to the hydrogen distribution unit 50 to instruct the hydrogen distribution unit 50 to send hydrogen to the hydrogen dispenser 60. Another control instruction is also sent to the hydrogen dispenser 60 to instruct the dispenser 60 to dispense hydrogen. The control program then returns to the monitoring stage 814.

Referring to FIG. 9C, a branch for continually selecting to fill the hydrogen storage system 70 is illustrated in a flowchart extending from the monitoring stage 814. In query 830 the control program checks an operational indicator indicating whether the hydrogen storage unit 70 is full, which determination may be made based on the pressure of the hydrogen in the storage unit 70. To this end, the pressure sensor located in the storage unit 70 sends a message to the data acquisition module 808 of the control unit 800 of FIG. 11. Based on this message, the data processor 802 determines if the hydrogen storage unit 70 is full. If the hydrogen storage unit 70 is full, the control program returns to monitoring stage 814. If, however, the storage unit 70 is not full, the control program proceeds to query 832, in which the control program checks an operating indicator indicating whether the storage unit 70 is ready to be filled. Storage unit 70 is ready to be filled when, for example, the pressure in the storage unit 70 has fallen below a certain preset value. This allows for more efficient use of high pressure compressor 40 depending on the preset value, since the compressor will not be used to top-up the storage unit 70 when hydrogen pressure in the storage unit 70 exceeds the pre-set value. If the storage unit 70 is not ready to be filled, because of a malfunction for example, the control program returns to monitoring stage 814. If, however, the storage unit 70 is ready to be filled, the control program proceeds to queries 834, 836, and 838 in parallel.

In query 834, the control program checks whether a user has selected to fill the hydrogen storage unit 70. A user may select to fill the hydrogen storage unit 70 by using the user interface 840 shown in FIG. 11. If a user has not selected to fill the hydrogen storage unit 70, the control program returns to monitoring stage 814. If, however, a user has selected to fill the hydrogen storage unit 70, the control program proceeds to step 842, in which the control program latches the hydrogen storage fill select. When an operation is latched, the control program ensures that the operation is continually selected and remains selected until the control program unlatches the operation. In this case, therefore, hydrogen storage is selected to be filled, and will remain so until it is unlatched by the control program when, for example, the hydrogen storage unit 70 is full. Following step 842, the control program returns to monitoring stage 814.

Queries 836, 844, and 846 relate to a special case in which fuel cell power generating unit 80 is running, and hydrogen storage unit 70 ceases to be ready to supply hydrogen to generating unit 80, i.e. the hydrogen pressure in storage unit 70 drops below a level at which power generating unit 80 is able to run. In query 836, the control program checks an operating indicator indicating whether the hydrogen storage unit 70 is ready to supply the fuel cell power generating unit 80 with hydrogen fuel. As described above with respect to FIG. 1, the fuel cell power generating unit 80 comprises one or more fuel cell power modules. The hydrogen storage unit 70 will be ready to supply the fuel cell power generating unit 80 when there is sufficient hydrogen in the storage unit 70 to run the fuel cell power generating unit 80, which determination the data processor 802 makes based on the pressure of the hydrogen in the storage unit 70 As described above, a pressure sensor located in the hydrogen storage unit 70 measures the hydrogen pressure and sends a signal to the data acquisition module 808 of the control unit 800 shown in FIG. 11. Based on this information, the data processor 802 then determines if the hydrogen pressure is sufficient to supply the fuel cell power generating unit 80. If the storage unit 70 is ready to supply the fuel cell power generating unit 80, the control program returns to monitoring stage 814. If, however, the storage unit 70 is not ready to supply the fuel cell power generating unit 80, the control program proceeds to query 844. In query 844, the control program checks whether the fuel cell power generating unit 80 is running. If the fuel cell power generating unit 80 is not running, the control program returns to monitoring stage 814. If, however, the fuel cell power generating unit 80 is running, the control program proceeds to query 846. In query 846, the control program checks an operating indicator indicating whether the hydrogen generation unit 824 is producing hydrogen gas. A sensor located in the hydrogen generation unit 824, which sends a message to the data acquisition module 808 of the control module 800 of FIG. 11, may, for example, be used by the data processor 802 to determine if the hydrogen generation unit 824 producing hydrogen. If the hydrogen generation unit 824 is not producing hydrogen, the control program returns to monitoring stage 814. If, however, the hydrogen generation unit 824 is producing hydrogen, the control program proceeds to step 842, in which the control program latches the hydrogen storage fill select. The control program then returns to monitoring stage 814.

In query 838, the control program checks an operating indicator indicating whether the hydrogen generation unit 824 is producing hydrogen. This determination may be made by the data processor 802 based on a message sent from a pressure sensor to the data acquisition module 808 in FIG. 11. If the hydrogen generation unit 824 is not producing hydrogen, the control program returns to monitoring stage 814. If, however, the hydrogen generation unit 824 is producing hydrogen, the control program proceeds to query 848. In query 848, the control program checks whether the hydrogen storage unit 70 is selected to fill. If the hydrogen storage unit 70 is selected to fill, the control program returns to monitoring stage 814. If, however, the hydrogen storage unit 70 is not selected to fill, the control program proceeds to query 850. In query 850 the control program checks an operating indicator that indicates whether the hydrogen storage unit 70 is being filled. If the hydrogen storage unit 70 is being filled, the control program returns to monitoring stage 814. If however, the hydrogen storage unit 70 is not being filled, the control program proceeds to queries 852, 854, and 856 in parallel.

In query 852, the control program checks whether the fuel cell power generating unit 80 is selected to run. If the fuel cell power generating unit 80 is not selected, the control program returns to monitoring stage 814. If however, the fuel cell power generating unit 80 is selected, the control program proceeds to query 858. Query 858 checks whether the hydrogen generation unit 824 is selected to run. This may be the case, for example, if a user selects to run the power generating unit 80 on hydrogen provided by the hydrogen generation unit 824 so as to reduce demand on hydrogen in storage unit 70. If the hydrogen generation unit 824 is selected to run, the control program returns to monitoring stage 814. If however, the hydrogen generation unit 824 is not selected to run, the control program proceeds to step 842, in which it latches the hydrogen storage fill select. The control program then returns to monitoring stage 814.

In query 854, the control program checks whether the fuel cell power generating unit 80 is deselected. The fuel cell power generating unit 80 could be deselected by the control unit 800 or a user, for example, in the event of an emergency stop, based on a message received by the data acquisition module 808. If the fuel cell power generating unit 80 is not deselected, the control program returns to monitoring stage 814. If however, the fuel cell power generating unit 80 is deselected, the control program proceeds to step 842, in which it latches the hydrogen storage fill select. The control program then returns to monitoring stage 814.

In query 856, the control program checks an operating indicator indicating whether the fuel cell power generating unit 80 is ready to generate electricity, which determination the data processor 802 may make, for example, based on a signal from a maintenance sensor, which determines the readiness of the fuel cell power generating unit 80 and then sends a message to the data acquisition module 808 of the control unit 800. If the fuel cell power generating unit 80 is ready to generate electricity, the control program returns to monitoring stage 814. If, however, the fuel cell power generating unit 80 is not ready to generate electricity, the control program proceeds to step 842, in which it latches the hydrogen storage fill select. The control program then returns to monitoring stage 814.

Referring to FIG. 9D, in which the depicted series of branches extending down form monitoring stage 814 all relate to conditions in which the selection that the H2 storage be filled will be unlatched. In query 860, the control program checks an operating indicator indicating if the hydrogen storage unit 70 is full, as similarly discussed above in relation to query 830 of FIG. 9C. If the hydrogen storage unit 70 is not full, the control program returns to monitoring stage 814. If, however, the hydrogen storage unit 70 is full, the control program proceeds to step 862, in which it unlatches the hydrogen storage fill select. The control program then returns to monitoring stage 814.

In query 864, the control program checks an operating indicator indicating whether the hydrogen storage unit 70 is ready to be filled, as similarly discussed above in relation to query 832 of FIG. 9C. If the hydrogen storage unit 70 is ready to be filled, the control program returns to monitoring stage 814. If, however, the hydrogen storage unit 70 is not ready to be filled, the control program proceeds to step 862, in which it unlatches the hydrogen storage fill select. The control program then returns to monitoring stage 814.

In query 866, the control program checks whether the hydrogen generation unit 824 is ready to generate hydrogen, as similarly discussed above in relation to query 846 of FIG. 9C. If the unit 824 is ready to generate hydrogen, then the control program returns to the monitoring stage 814. If, however, the hydrogen generating unit 824 is not ready to generate hydrogen, the control program proceeds to step 862, in which it unlatches the hydrogen storage fill select, as unless an external source of hydrogen is provided, the hydrogen storage unit 70 cannot be filled if the hydrogen generation unit 824 is not ready to generate hydrogen. The control program then returns to monitoring stage 814.

In query 868, the control program checks whether the hydrogen storage unit 70 is deselected. The hydrogen storage unit 70 could be deselected, for example, by a user or, alternatively, in the event of an emergency stop based on a message received by the data acquisition module 808. If the hydrogen storage unit 70 is not deselected, the control program will return to monitoring stage 814 If, however, the hydrogen storage unit 70 is deselected, the control program proceeds to step 862, in which it unlatches the selection that the hydrogen storage be filled. The control program then returns to monitoring stage 814.

In query 870, the control program checks an operating indicator indicating whether the hydrogen storage unit 70 is being filled. If the hydrogen storage unit 70 is not being filled, then the control program returns to monitoring stage 814. If however, the hydrogen storage unit 70 is being filled, the control program proceeds to queries 872 and 874, in parallel.

In query 872, the control program checks an operating indicator indicating whether the hydrogen generation unit 824 is running. If the hydrogen generation unit 824 is running, the control program returns to monitoring stage 814. If, however, the hydrogen generation unit 824 is not running, the control program proceeds to step 862, in which it unlatches the hydrogen storage fill select. The control program then returns to monitoring stage 814.

In query 874, the control program checks an operating indicator indicating whether the hydrogen generation unit 824 is producing hydrogen gas. If the hydrogen generation unit 824 is producing gas, the control program will return to monitoring stage 814. It is possible, during start-up, for example, that the hydrogen generation unit 824 would be running but not producing hydrogen gas. If, however, the hydrogen generation unit 824 is not producing hydrogen gas, the control program proceeds to step 862, in which it unlatches the hydrogen storage fill select. The control program then returns to monitoring stage 814.

In query 876, the control program checks an operating indicator indicating whether the hydrogen storage unit 70 is being filled. If the hydrogen storage unit 70 is not being filled, the control program returns to monitoring stage 814. If, however, the hydrogen storage unit 70 is being filled, the control program proceeds to query 878. In query 878, the control program checks whether the hydrogen generation unit 824 is selected. If the hydrogen generation unit 824 is not selected, the control program returns to monitoring stage 814. If, however, the hydrogen generation unit 824 is selected, the control program proceeds to query 880. In query 880, the control program checks whether a user has selected to run the fuel cell power generating unit 80. If a user has not selected to run the fuel cell power generating unit 80, the control program returns to monitoring stage 814. If, however, a user has selected to run the fuel cell power generating unit 80, the control program proceeds to step 862, in which it unlatches the hydrogen storage fill select. The control program then returns to monitoring stage 814. This reflects the fact that in the power/hydrogen generator system of FIG. 10, the fuel cell power generating unit 80 will consume all of the hydrogen generated by the hydrogen generation unit 824. However, in other embodiments, the hydrogen generation unit 824 may produce a surplus of hydrogen in addition to that consumed by the fuel cell power generating unit 80 such that this additional hydrogen can be stored. In such embodiments, the control program would not necessarily specify that the hydrogen storage fuel select be unlatched under the circumstances defined by queries 876, 878 and 880 described above.

Referring to FIG. 9E, a branch for continually selecting to run the fuel cell power generation unit 80 is illustrated in a flowchart extending from the monitoring stage 814. In query 882, the control program checks an operating indicator indicating whether the hydrogen storage unit 70 is ready to supply the fuel cell power generating unit 80 with hydrogen fuel, as similarly discussed above in relation to query 836 of FIG. 9C. If the storage unit 70 is not ready to supply the fuel cell power generating unit 80, the control program returns to monitoring stage 814. If, however, the storage unit 70 is ready to supply the fuel cell power generating unit 80, the control program proceeds to query 884. In query 884, the control program checks an operating indicator indicating whether the fuel cell power generating unit 80 is ready to run. The fuel cell power generating unit would not be ready to run, for example, if the control program detected an emergency stop signal. If the fuel cell power generating unit 80 is not ready to run, the control program returns to monitoring stage 814. If, however, the fuel cell power generating unit 80 is ready, the control program proceeds to query 886. In query 886, the control program checks an operating indicator indicating whether the fuel cell power generating unit 80 is running. If the fuel cell power generating unit 80 is running, the control program returns to monitoring stage 814. If, however, the fuel cell power generating unit 80 is not running, the control program will proceed to query 888. In query 888, the control program checks whether a user has selected to run the fuel cell power generating unit 80. If a user has not selected to run the fuel cell power generating unit 80, the control program returns to monitoring stage 814. If, however, a user has selected to run the fuel cell power generating unit 80, the control program proceeds to step 890, in which the it latches the fuel cell power generating unit run selected. The control program then returns to monitoring stage 814.

Referring to FIG. 9F, a branch for unlatching the run select for the electricity generation unit 80 is illustrated in a flowchart extending from the monitoring stage 814. In query 892, the control program checks an operating indicator indicating whether the hydrogen storage unit 70 is ready to supply the fuel cell power generating unit 80 with hydrogen fuel, as similarly discussed above in relation to query 836 of FIG. 9C If the storage unit 70 is ready to supply the fuel cell power generating unit 80, the control program returns to monitoring stage 814. If, however, the storage unit 70 is not ready to supply the fuel cell power generating unit 80, the control program proceeds to step 894, in which it unlatches the fuel cell power generating unit run selected. The control program then returns to monitoring stage 814.

In query 896, the control program checks whether the fuel cell power generating unit 80 is ready to run, as similarly discussed in relation to query 884 of FIG. 9E. If the fuel cell power generating unit 80 is ready to run, the control program returns to monitoring stage 814. If, however, the fuel cell power generating unit 80 is not ready to run, the control program proceeds to step 894, in which it unlatches the fuel cell power generating unit run selected. The control program then returns to monitoring stage 814.

In query 898, the control program checks whether a user has deselected the fuel cell power generating unit 80. A user may deselect the fuel cell power generating unit 80 when, for example, he or she no longer requires electricity or no longer wishes the fuel cell power generating unit 80 to run. If the fuel cell power generating unit is not deselected, the control program returns to monitoring stage 814. If, however, the fuel cell power generating unit 80 is deselected, the control program proceeds to step 894, in which it unlatches the fuel cell power generating unit run selected. The control program then returns to monitoring stage 814.

In query 900, the control program checks whether the storage of hydrogen in the hydrogen storage unit 70 has been selected. If storage of hydrogen in the hydrogen storage unit 70 has not been selected, then the control program returns to monitoring stage 814. On the other hand, if storage of hydrogen in the hydrogen storage unit 70 has been selected, then the control program proceeds to query 902. In query 902, the control program checks the operating indicator indicating whether the hydrogen generation unit 824 is producing hydrogen gas, as similarly discussed above in relation to step 838 of FIG. 9C. If the hydrogen generation unit 824 is not producing hydrogen gas, the control program returns to monitoring stage 814. If, however, the hydrogen generation unit 824 is producing hydrogen gas, the control program proceeds to step 894, in which it unlatches the fuel cell power generating unit run selected. After unlatching the fuel cell power generating unit when selected, the control program will return to the monitoring stage 814.

Referring to FIG. 9G, an electricity generation unit run branch extending from the monitoring stage 814 is illustrated in a flowchart. In query 904, the control program checks an operating indicator indicating whether the hydrogen storage unit 70 is ready to supply the fuel cell power generating unit 80 with hydrogen fuel, as similarly discussed above in relation to query 836 of FIG. 9C. If the storage unit 70 is not ready to supply the fuel cell power generating unit 80, the control program proceeds to step 906, in which it deselects and disables the fuel cell power generating unit run select, i.e. if the fuel cell power generating unit run has been selected, then this is deselected, and the user interface module 840 of control unit 800 is modified to disable the select function for fuel cell power generating unit run, such that a user can no longer make this selection. The control program then returns to monitoring stage 814. If, however, the storage unit 70 is ready to supply the fuel cell power generating unit 80, the control program proceeds to query 908. In query 908, the control program checks an operating indicator indicating whether the fuel cell power generating unit 80 is ready to run. If the fuel cell power generating unit 80 is not ready, the control program proceeds to step 910, in which it deselects and disables the fuel cell power generating unit run select, as described above. The control program then returns to monitoring stage 814. If, however, the fuel cell power generating unit 80 is ready, the control program proceeds to step 912, in which it enables the fuel cell power generating unit 80 to be selected by restoring the appropriate selection function to the user interface module 840 of the control unit 800. The control program then proceeds to query 914. In query 914, the control program checks whether the fuel cell power generating unit 80 is selected. If the fuel cell power generating unit 80 is not selected, the control program returns to monitoring stage 814. If, however, the fuel cell power generating unit is selected, the control program proceeds to queries 916 and 918, in parallel.

In query 916, the control program checks an operating indicator indicating whether the hydrogen storage unit 70 is being filled. If the storage unit 70 is being filled, the control program returns to monitoring stage 814. If, however, the storage unit 70 is not being filled, the control program proceeds to query 920. In query 920, the control program checks whether the hydrogen storage unit 70 is selected to fill. If the hydrogen storage unit 70 is not selected to fill, the control program returns to monitoring stage 814. If, however, the hydrogen storage unit 70 is selected to fill, the control program proceeds to step 922, in which the control program sends a control instruction from the control unit 800 to start the fuel cell power generating unit 80. The control program also sends a distribution unit control instruction is also sent from the control unit 800 to the hydrogen distribution unit 50 instructing the distribution unit 50 to send hydrogen to fuel cell power generating unit 80. The control program then returns to monitoring stage 814.

In query 918, the control program checks whether the hydrogen storage unit 70 is selected to fill. If the hydrogen storage unit 70 is selected to fill, the control program returns to monitoring stage 814. If, however, the hydrogen storage unit is not selected to fill, the control program proceeds to step 922, in which it sends a control instruction from the control unit 800 to start the fuel cell power generating unit 80. The control program then returns to monitoring stage 814.

Referring to FIG. 9H, a hydrogen storage fill branch extending from the monitoring stage 814 is illustrated in a flowchart. In query 924, the control program checks an operating indicator indicating whether the hydrogen storage unit 70 is full, as similarly discussed above in relation to query 830 of FIG. 9C. If the hydrogen storage unit 70 is full, the control program proceeds to step 926, in which it deselects and disables the hydrogen storage select, which prevents the hydrogen storage unit 70 from being selected to fill. The control program then proceeds to step 928. In step 928, the control program deselects the hydrogen storage force fill, which prevents the hydrogen storage unit 70 from being force filled while the hydrogen storage unit 50 is full. Force filling can otherwise take place, for example, in the event of an emergency stop resulting in the power generating unit 80 being shut-down, so as to allow the hydrogen generation unit 824 to continue running and thereby provide hydrogen to the hydrogen storage unit 50. The control program then returns to monitoring stage 814. If, however, the hydrogen storage bank 70 is not full, the control program proceeds from query 924 to query 930. In query 930, the control program checks an operating indicator indicating whether the hydrogen storage unit 70 is ready to be filled, as similarly discussed above in relation to query 832 of FIG. 9C. If the hydrogen storage unit 70 is not ready to be filled, the control program proceeds to steps 926 and 928, in series, described above, and then returns to monitoring stage 814. If, however, the hydrogen storage unit 70 is ready to be filled, the control program proceeds to step 932, in which it enables the hydrogen storage unit 70 to be selected to be filled. The control program then proceeds to query 934. In query 934, the control program checks whether hydrogen storage is selected. If hydrogen storage is not selected, the control program returns to monitoring stage 814. If, however, hydrogen storage is selected, the control program proceeds to query 936. In query 936, the control program checks an operating indicator indicating whether the hydrogen generation unit 824 is producing hydrogen gas, as similarly discussed above in relation to query 838 of FIG. 9C. If the hydrogen generation unit 824 is not producing hydrogen gas, the control program returns to monitoring stage 814. If, however, the hydrogen generation unit 824 is producing hydrogen gas, the control program proceeds to query 938. In query 938, the control program checks an operating indicator indicating whether the fuel cell power generating unit 80 is running. If the fuel cell power generating unit 80 is running, the control program returns to monitoring stage 814. If, however, the fuel cell power generating unit 80 is not running, the control program proceeds to step 940, in which it sends a control instruction from the control unit 800 to start filling the hydrogen storage unit 70. A distribution unit control instruction is also sent from the control unit 800 to the hydrogen distribution unit 50 instructing the distribution unit 50 to send hydrogen to the hydrogen storage unit 70. The control program then returns to monitoring stage 814.

Referring to FIG. 9I, a hydrogen generation unit run branch extending from the monitoring stage 814 is illustrated in a flowchart. In query 942, the control program checks an operating indicator indicating whether there is sufficient hydrogen in the storage unit 70 to begin running the hydrogen generation unit 824, as similarly discussed above in relation to query 812 of FIG. 9A. If there is insufficient hydrogen in the hydrogen storage unit 70, then the control program returns to monitoring stage 814. If, however, there is sufficient hydrogen in the hydrogen storage unit 70 to run the hydrogen generation unit 824, then the control program proceeds to queries 944 and 946, in parallel.

In query 944, the control program checks whether the fuel cell power generating unit 80 is selected. If the fuel cell power generating unit 80 is not selected, the control program returns to monitoring stage 814. If, however, the fuel cell power generating unit 80 is selected, the control program proceeds to query 948. In query 948, the control program checks whether the hydrogen generation unit 824 is selected to run. If the hydrogen generation unit 824 is not selected to run, the control program returns to monitoring stage 814. If, however, the hydrogen generation unit 824 is selected to run, the control program proceeds to query 950. In query 950, the control program checks an operating indicator indicating whether the hydrogen generation unit 824 is ready to run. If the hydrogen generation unit 824 is not ready to run, the control program returns to monitoring stage 814. If, however, the hydrogen generation unit 824 is ready to run, the control program proceeds to step 952, in which it sends a generation unit control instruction from the control unit 800 to start the hydrogen generation unit 824. The control program then returns to monitoring stage 814.

In query 946, the control program checks whether the hydrogen storage bank 70 is selected to fill. If the hydrogen storage bank 70 is not selected to fill, the control program returns to monitoring stage 814. If, however, the hydrogen storage bank 70 is selected to fill, the control program proceeds to query 950 and then proceeds from query 950 as discussed above.

Referring to FIG. 9J, a branch extending from the monitoring stage 814 is illustrated in a flowchart, which relates to conditions that must be met in order for the control program to instruct the distribution unit 50 to send gas to the fuel cell power generating unit 80. In query 954, the control program checks an operating indicator indicating whether the fuel cell power generating unit 80 is running. If the fuel cell power generating unit 80 is not running, the control program returns to monitoring stage 814. If, however, the fuel cell power generating unit 80 is running, the control program proceeds to query 956. In query 956, the control program checks an operating indicator indicating whether the hydrogen generation unit 824 is producing hydrogen gas, as similarly discussed above in relation to query 838 of FIG. 9C. If the hydrogen generation unit 824 is not producing hydrogen gas, the control program returns to monitoring stage 814. If, however, the hydrogen generation unit 824 is producing hydrogen gas, the control program proceeds to query 958. In query 958, the control program checks an operating indicator indicating whether the hydrogen storage unit 70 is being filled. If the hydrogen storage unit 70 is being filled, the control program returns to monitoring stage 814. If, however, the hydrogen storage unit 70 is not being filled, the control program proceeds to query 960. In query 960, the control program checks whether the hydrogen generation unit 824 is selected to run. If the hydrogen generation unit 824 is not selected to run, then the control program returns to monitoring stage 814. If, however, the hydrogen generation unit 824 is selected to run, the control program proceeds to step 962, in which it sends a distribution unit control instruction from the control unit 800 to the hydrogen distribution unit 50 instructing the hydrogen distribution unit 50 to send hydrogen to the fuel cell power generating unit 80. The control program then returns to monitoring stage 814. Set out below is the more detailed description of many of the components of the power/hydrogen generator system of FIG. 1.

SMR Based Fuel Processor

The use of hydrogen from the PSA 30, compressed storage and/or an external source, if required, enables a quick start up. The PSA Tail-Gas (or waste/purge gas) is used in the burner reaction to lower the amount of natural gas required and improve efficiency. The use of a buffer between the SMR based fuel processor 10 and the PSA 30 as a performance stabilization module prevents the two from communicating or influencing each other. The system is pressure controlled to achieve a balanced operation. The moisture removal is achieved with a chiller based heat exchanger system that controls and optimizes the temperature in the reformate stream and maintains optimum performance. The thermal management of the fuel processor 10 is handled with the heat exchanger system to capture the heat for CHP (combined heat and power) purposes (see thermal management system). Make-up purified water is supplied to the condensate separator to ensure the boiler on the fuel processor maintains a constant level to ensure performance. The flue gases and combustion gases are collected and routed to their respective exhaust headers.

The Reformate (Syngas) Boost Compressor

A significant issue with reformate gas is that the compressor used must not only be of hydrogen compatible construction, but must resist the corrosive qualities of the reformate gas due to the significant concentrations of carbon dioxide and moisture. A special compressor has been specified and delivered in the two stage syngas compressor 20, which was selected due to its successful history operating under these harsh operating conditions. Once compressed, the reformate gas will flow through a coalescing pre-filter, where oil and water droplets are removed via condensate traps, and then through absorption filters where oil vapour is removed. The reformate gas is then injected directly to the PSA system 30 and purified. The supply to the compressor 20 has safeguards to prevent a vacuum condition being created which could possibly introduce oxygen into the hydrogen stream. To achieve this there are positioning switches on the inlet valve that will shut the compressor 20 down if the valves are not 100% open. Further, a purge valve is installed between the two inlet valves to purge or evacuate the system during service, and a recycle pressure line that will inject hydrogen from the discharge in case of low suction pressure is also provided. A low pressure switch is arranged to shut the compressor 20 down in case of low pressure. The condensate from the compressor 20 is collected in a common condensate collection vessel that is discharged from the system. The thermal management of the compressor 20 is handled with a properly sized heat exchanger to capture the heat for CHP purposes (see thermal management system). The discharge system has a four stage filtration package that removes any entrained oil in the hydrogen gas stream. This system includes a coarse coalescing filter, a fine coalescing filter, an activated carbon filter and a superfine particulate filter. The filters are monitored with a common differential pressure switch, which provides an alarm if the filters are overly contaminated. The discharge from the filters is sent to the common condensate collection vessel. All venting devices are commoned and routed to the combustible gas header for venting.

Syngas Purification System: Pressure Swing Adsorption (PSA) System

The reformate gas is supplied to the PSA system 30. Near pure hydrogen exits the PSA system 30 at a minimum of 99.95% purity, with less than 5 ppm carbon monoxide. The product recovery is expected at greater than 76% (it is the volumetric ratio of hydrogen product to the amount of hydrogen supplied to the PSA 30), which would produce a minimum recovered hydrogen flow rate of 35 NCMH (normal cubic meters per hour). The near pure hydrogen will then be supplied to a high-pressure compressor to be pressurized and sent to storage; PSA off-gas will be recovered and sent to the SMR based fuel processor 10 for steam generation. The purification system has an advanced 6-bed PSA process with a simple, compact design. A multi-port control valve provides smooth operation. All materials on the beds are stainless steel, electro-plated or powder coated to inhibit any corrosion.

The High Pressure Gas Compressor

The requirement to compress hydrogen to high pressures (typically 5000 psi(g)) requires a special gas compressor as it must not only be of hydrogen compatible construction, but must also exhibit superior sealing capacity to contain hydrogen at very high pressures. This special configuration has been specified and delivered in the multi-stage compressor 40, which has a successful history operating in this application. The high-pressure hydrogen compressor 40 is a multi-stage, oil-lubricated, water-cooled reciprocating compressor. The compressor 40 is designed to operate on an automatic start and stop system. The control system needs a time delay on the unloader system so that the compressor 40 starts in the unloaded condition in order to allow the compressor 40 to reach normal operating speed under minimum load conditions. Hydrogen from the compressor 40 flows to a coalescing pre-filter where oil and water droplets are removed via condensate traps, and then through absorption filters where oil vapour is removed. The high-pressure hydrogen gas is then supplied to the storage system 70. The gas supply to the compressor 70 has safeguards, such as a pressure switch and/or external supply of start-up gas, to prevent a vacuum condition from being created which could possibly introduce oxygen into the hydrogen stream. To achieve this the gas supply includes the following elements: positioning switches on the inlet valve that will shut the compressor 40 down if the valves are not 100% open; a purge valve installed between the two inlet valve to purge or evacuate the system during service; a recycle pressure line that will inject hydrogen from the discharge in case of low suction pressure; and a low pressure switch that will shut the compressor 40 down in case of low pressure. The condensate from the compressor 40 is collected in a common vessel that is discharged from the system. The thermal management of the compressor is handled with a properly sized heat exchanger to capture the heat for CHP purposes (see thermal management system). The discharge system has a four stage filtration package that removes any entrained oil in the hydrogen gas stream. This system includes a course coalescing filter, a fine coalescing filter, an activated carbon filter and a superfine particulate filter. The filters are monitored with a common differential pressure switch which provides an alarm if the filters are overly contaminated. The discharge of these filter are sent to the common condensate collection vessel. All venting devices are commoned and routed to the combustible gas header.

The High Pressure Gas Distribution System

This system allows the power/hydrogen generator system to receive hydrogen from the compressors 40 at a high pressure (typically 5000 psi(g)), from an external source 510 at whatever pressure is available and to compress the hydrogen received from the external source 510 by routing it through the high pressure compressor 40. This gives the power/hydrogen generator system significant flexibility to manage its sources. The cascade control of the multiple banks of hydrogen storage vessels allows the process to fill or consume the storage, sequentially. This allows optimum performance of hydrogen gas management. The distribution system 50 routes the hydrogen to any part of the system in order to maximize start-up, recovery, safety response and delivery.

High Pressure Storage

The high pressure storage system 70 comprises ten composite cylinders. The cylinders are designed for a maximum pressure of 6425 psi(g) but the working pressure should not exceed a maximum pre-set value, typically 5000 psi(g). The ten cylinders, when filled to the normal maximum storage pressure of 5000 psi(g), will hold approximately 47.5 kg of hydrogen. The amount of storage can be adjusted to suit the intended application, of course. The cylinders are mounted on a frame made of aluminum. Each cylinder is held in place in the frame with two lightweight brackets. High-pressure stainless steel tubing is used in the system for connecting the cylinders for filling and emptying. A thermal pressure relief device is installed in each of the two ports of each cylinder. The filling line connects the compressor 40 to the cylinders. The cylinders are filled and emptied through the same line. The venting lines are required for gas release from the temperature activated pressure relief devices (PRD), and these vent to atmosphere through one central vent line. The vent lines are made from galvanized steel. All connections between the tubing, valves, and other system components are made using industry proven mechanical compression fittings.

The Fuel Dispensing System

The filling station is located adjacent to the high-pressure hydrogen storage system 70, and consists of the dispenser 60 and the piping connecting the dispenser 60 to the gas storage. The connection of the gas storage vessels allows the operator to fill vehicles 820 and meter the quantity involved in the filling. The process allows the operator to fuel/dispense fuel to the vehicle storage in fast or slow fill or manual mode. Manual mode is the least efficient and allows the operator to fill under his control and discretion. The slow fill is enabled to minimize the heat generated by the recompression of the hydrogen in the vehicle storage vessel. Excessive heat in the storage vessel could cause damage or failure. Fast fill is controlled to fill to the limit of heat generated either through a control algorithm or feed back control from the vehicle storage vessel.

Feed Water System

The feed water system consists of reverse osmosis (RO) system and DI water filters. The RO water is required for the SMR based fuel processor 10 and the DI water for polishing the fuel cell power module. The RO system is continuous and regenerative where the DI system is consumable.

Thermal Management System

The power/hydrogen generator system delivers heat via coolant to a common thermal management system 100, where currently, the heat is rejected to the atmosphere via a large radiator. The system could easily be adapted to mate with a heating system for a building by capturing the heat and transmitting it to the building structure through heat exchange with the hot water boiler line. The thermal management system 100 operates with a closed loop heat exchanger inserted in the return line prior to re-entering the boiler, serving as a boiler pre-heater. If the heat becomes excessive the onboard radiators will engage to reject as much heat as is required to maintain process integrity. The temperature of water exiting the boiler is typically in the range of 55 to 65 degrees C. for low pressure systems. When the system is operating at full capacity the return temperature to the boiler is 45 to 55 degrees C. The fuel cell cooling loop will be of high purity stainless steel using DI water (deionized water) as the heat transfer fluid; the processor and purification cooling loops will be constructed from copper and use a water/glycol solution. The fuel cell power generating unit 80 also rejects a substantial amount of heat through the cathode exhaust. This heat can be captured to heat the process during cold climatic periods and could be utilized by the end user if his building required forced air heating. The heating value is significant when compared to the energy value of the make-up air for the building.

Fuel Cell Power Generating Unit

The system includes six fuel cell stacks electrically in series and process wise in parallel, a common air blower, six sets of energy exchange devices, and a series of flow control devices. The number of fuel cell stacks is, of course, dependent on the required output of the system. The fuel cell power generating unit 80 is capable of generating raw DC power at a nominal 82.5 kW. The fuel cell is designed to accept high purity hydrogen fuel (99.95%). Its integration with the power conditioning system is optimized to deliver up to 50 kW of clean AC power. The high performance fuel cell stack operates near ambient pressure. A humidification subsystem utilizes water generated by the fuel cell to humidify the and cathode stream, while the high purity fuel cell stack cooling water is utilized in a humidification contactor to humidify the anode stream; all humidification devices are contained within a compact footprint, i.e. of a small physical size, allowing for a very dynamic and fast responding power range. The fuel cell stack is intended for dead-ended fuel operation, which will minimize anode purge, minimize hydrogen consumption and eliminate the. venting of excess hydrogen, thereby improving fuel cell efficiency and system performance. The fuel cell power generating unit 80 balance of plant is designed to maintain stable dew point, pressure and temperature profiles across the stack. The energy and moisture is recycled from the exhaust gases to maximize efficiency and water neutrality. The fuel cell stack interfaces with the balance of plant are designed to optimize stack interaction with the fuel processor, thermal management module and the power electronics. The fuel interface with the fuel processor involves receiving approximately 800 slpm of high purity hydrogen (99.95%) at 15-20 psi(g) and 65 degrees C. The fuel cell power generating unit 80 operates in a “dead-end” mode where the hydrogen feed will be at a stoichiometry of 1.02, and the hydrogen purge flows to the fuel processor to be consumed in the burner. Air is supplied to the fuel cell power generating unit 80 from a common system blower in a flow mode at a stoichiometry of 2-2.2 and it is optimal to use the cathode off-gas to be recycled to the fuel processor burner for the creation of steam. The fuel cell power generating unit 80 is designed to be water neutral; however there may be a requirement to have de-ionized water make-up on an intermittent basis. This can be achieved by using a small de-ionized water polisher. The excess water that the fuel cell power generating unit 80 generates is recycled and used in the system. The heat generated by the fuel cell is captured and made available to the thermal management module 100 by means of a FCPM cooling water system/heat exchanger.

Power Electronics System

The power conditioning module is designed to deliver 50 kW of grid synchronized power to a user and to maximize the performance and durability of the fuel cell stack while providing peak shaving and back up power. The use of high efficiency (>95%) isolation transformers is likewise essential in providing overall efficiency. The power management system is based on an IGBT (Insulated Gate Bipolar Transistor) four-quadrant switching mode power converter with capabilities of controlling both active and reactive power. This enables the converter to be used for power factor correction and improves the power quality supplied to the host facility.

Overall Package Integration

The overall process and equipment integration is to “containerise” the power/hydrogen generator system to function in an automated and safe operation. The sub-components have been designed and optimised to produce a seamless interaction of the process, so that the operation from the operator point of view is as a single piece of equipment. The housing is constructed to ISO shipping container standards for ease of shipment, ruggedness, and rigid base. The entire wall (interior and exterior) is fabricated to conform to a two fire rating as stated in the NFPA and NEC fire and electrical codes. The control or non-hazardous areas are located at one end of the container and along side the process (hazardous) areas to minimize the control interfaces. This allows the process device and its controller to be situated close to each other but in different rated areas. This provides a significant cost savings. The syngas storage is located in the open portion of the container which is open at the top and bottom. This allows any hydrogen that manages to leak to escape in a safe manner. The thermal management package is mounted in the roof of the housing to allow good ventilation, environmental control of the process area, and to save valuable wall space. The ventilation is equipped with actuating covers that open and close on command. This with the variable speed cooling fans modulates the temperature in the container and the cooling system. Alternative placement of the sub-components of the system is envisioned for different system requirements.

Control System

The overall control algorithm and process control (see FIGS. 9A to 9J) is designed and optimised to produce a seamless interaction of the process, so that the operation from the operator point of view is as a single piece of equipment.

It should be appreciated that the spirit of the present invention is concerned with the novel structure of the fuel cell system and the regulation of the system. The internal structure of the fuel cell portion does not affect the design of the present invention. In other words, the present invention is applicable to various types of fuel cells.

Other variations or modifications of the invention are possible. For example, sources of hydrogen other than the SMR based fuel processor described above may be employed. For example, a hydrogen storage device such as a tube trailer could supply the required hydrogen. As well, hydrogen could be provided by an electrolyser. More generally, the invention could be used as a stationary power and hydrogen supply for a hydrogen refuelling station, or the invention could provide power and hydrogen for a mobile refuelling station as could be installed on a truck or other vehicle, for example. In alternate configurations, the hydrogen dispenser could comprise a plurality of dispenser modules, each adapted to fill the fuel tanks of a hydrogen powered vehicle. All such modifications or variations are believed to be within the sphere and scope of the invention as defined by the claims appended hereto.

1. A hydrogen distribution system comprising:
a hydrogen source;
a plurality of hydrogen receiving units for selectably receiving hydrogen gas;
a hydrogen distribution unit for receiving hydrogen gas from the hydrogen source and for distributing hydrogen gas between the plurality of hydrogen receiving units, wherein the plurality of hydrogen receiving units are connected to the hydrogen distribution unit in parallel; and
a control unit for providing a plurality of control instructions, the plurality of control instructions comprising (i) at least one hydrogen source control instruction for controlling the hydrogen source, (ii) at least one receiving unit control instruction for controlling at least one of the hydrogen receiving units, and (iii) at least one distribution unit control instruction for controlling the hydrogen distribution unit.

2. The hydrogen distribution system as defined in claim 1 wherein the control unit comprises a user interface for receiving user input data and a data processor configured by a control program to determine the plurality of control instructions based on the user input data.

3. The hydrogen distribution system as defined in claim 1 wherein the control unit comprises a user interface for receiving user input data and a data processor configured by a control program to determine the plurality of control instructions based on the user input data.

4. The hydrogen distribution system as defined in claim 3 wherein the plurality of operating indicators comprises at least one hydrogen supply pressure indicator for indicating a hydrogen supply pressure that is suppliable to the plurality of hydrogen receiving units.

5. The hydrogen distribution system as defined in claim 4 wherein the at least one hydrogen supply pressure indicator comprises a hydrogen source pressure indicator for indicating a hydrogen source pressure.

6. The hydrogen distribution system as defined in claim 4 wherein
at least one of the hydrogen receiving units is a fuel cell power module;
the at least one receiving unit instruction comprises a fuel cell power module control instruction for controlling the fuel cell power module;
the user interface comprises a fuel cell power module indicator for selecting the fuel cell power module; and
the control program is operable to determine the fuel cell power module control instruction based on whether the fuel cell power module has been selected.

7. The hydrogen distribution system as defined in claim 6 wherein
at least one of the hydrogen receiving units is a refueler for dispensing hydrogen;
the at least one receiving unit instruction comprises a refueler control instruction for controlling the refueler;
the user interface comprises a refueler indicator for selecting the refueler; and,
the control program is operable to determine the refueler control instruction based on whether the refueler has been selected.

8. The hydrogen distribution system as defined in claim 7 wherein the data processor configured by the control program is operable to
disable the fuel cell power module indicator such that the fuel cell power module indicator cannot be selected if the hydrogen supply pressure is below a fuel cell power module threshold pressure; and
disable the refueler indicator such that the refueler indicator cannot be selected if the hydrogen supply pressure pressure is below a refueler threshold pressure.

9. The hydrogen distribution system as defined in claim 4 wherein (i) the hydrogen source is a hydrogen generation unit for generating hydrogen; (ii) at least one of the plurality of hydrogen receiving units is a storage unit for storing hydrogen, (iii) the storage unit has an associated pressure sensor for measuring a storage pressure, (iv) the plurality of receiving unit operating conditions includes the storage pressure measured by the associated pressure sensor, and (iv) the hydrogen supply pressure is determined, at least in part, based on the storage pressure.

10. The power hydrogen generator system as defined in claim 9 wherein the storage unit for storing hydrogen further comprises a plurality of storage modules for storing hydrogen at different pressures, and the control program is operable to selectably distribute hydrogen stored at different pressures in the storage modules to a receiving unit based on a receiving unit operating condition.

11. The hydrogen distribution system as defined in claim 4 wherein, for at least one of the hydrogen receiving units,
the user interface comprises an associated indicator for selecting that hydrogen receiving unit,
the at least one receiving unit instruction comprises an associated receiving unit control instruction for controlling that hydrogen receiving unit; and,
the control program is operable to determine the associated control instruction based on whether the associated indicator has been selected.

12. The hydrogen distribution system as defined in claim 11 wherein the hydrogen receiving unit having the associated indicator has a minimum supply pressure and the data processor configured by the control program is operable to disable the associated indicator if the hydrogen supply pressure is below the minimum supply pressure.

13. A method of distributing hydrogen from a hydrogen source to a plurality of receiving units via a hydrogen distribution system, the method comprising:
(a) monitoring a hydrogen source and a plurality of hydrogen receiving units to determine a plurality of operating indicators, the plurality of operating indicators comprising (i) a hydrogen source operating condition for indicating an operating condition of the hydrogen source, (ii) at least one receiving unit operating condition for indicating operating conditions of at least one of the hydrogen receiving units;
(b) determining a plurality of control instructions based on the plurality of operating indicators, the plurality of control instructions comprising (i) at least one hydrogen source control instruction for controlling the hydrogen source, (ii) at least one receiving unit control instruction for controlling at least one of the hydrogen receiving units, and (iii) at least one distribution unit control instruction for controlling the hydrogen distribution unit; and
(c) based on the plurality of control instructions, controlling (i) the hydrogen source and the hydrogen distribution system to selectably provide hydrogen to the plurality of hydrogen receiving units, and (ii) operation of at least one hydrogen receiving unit.

14. The method as defined in claim 13 further comprising providing user input data via a user interface, wherein step (b) further comprises determining the plurality of control instructions based on the user input data.

15. The method as defined in claim 14 wherein the plurality of operating indicators comprises at least one hydrogen supply pressure indicator for indicating a hydrogen supply pressure that is suppliable to the plurality of hydrogen receiving units.

16. The method as defined in claim 15 wherein
at least one of the hydrogen receiving units is a fuel cell power module;
the at least one receiving unit control instruction comprises a fuel cell power module control instruction for controlling the fuel cell power module;
the user interface comprises a fuel cell power module indicator for selecting the fuel cell power module; and
the method further comprises determining the fuel cell power module control instruction based on whether the fuel cell power module has been selected.

17. The method as defined in claim 16 wherein
at least one of the hydrogen receiving units is a refueler for dispensing hydrogen;
the at least one receiving unit control instruction comprises a refueler control instruction for controlling the refueler;
the user interface comprises a refueler indicator for selecting the refueler; and,
the method further comprises determining the refueler control instruction based on whether the refueler has been selected.

18. The method as defined in claim 13 further comprising
disabling the fuel cell power module indicator such that the fuel cell power module indicator cannot be selected if the hydrogen supply pressure is below a fuel cell power module threshold pressure; and
disabling the refueler indicator such that the refueler indicator cannot be selected if the hydrogen supply pressure pressure is below a refueler threshold pressure.

19. The method as defined claim 15 wherein
at least one of the hydrogen receiving units is a storage unit for storing hydrogen at different pressures, and step (c) further comprises selectably providing hydrogen stored at different pressures in the storage modules to a receiving unit based on a receiving unit operating condition.

20. The method as defined in claim 15 wherein, for at least one of the hydrogen receiving units,
the user interface comprises an associated indicator for selecting that hydrogen receiving unit,
the at least one receiving unit instruction comprises an associated receiving unit control instruction for controlling that hydrogen receiving unit; and,
the method further comprises determining the associated control instruction based on whether the associated indicator has been selected.

21. The method as defined in claim 20 wherein the hydrogen receiving unit having the associated indicator has a minimum supply pressure, and the method further comprises disabling the associated indicator if the hydrogen supply pressure is below the minimum supply pressure.
